(19) United States
(12) Patent Application Publication
(10) Pub. No.: US 2016/0370580 A1
(43) Pub. Date: Dec. 22, 2016

(54) OPTICAL ELEMENT, LENS UNIT, IMAGING MODULE, ELECTRONIC APPARATUS, AND METHOD OF MANUFACTURING OPTICAL ELEMENT

(71) Applicant: FUJIFILM Corporation, Tokyo (JP)

(72) Inventors: Goro TAKADA, Saitama-shi (JP); Takeharu TANI, Ashigarakami-gun (JP); Hiroki TAKAHASHI, Saitama-shi (JP); Yasunobu KISHINE, Saitama-shi (JP)

(73) Assignee: FUJIFILM Corporation, Tokyo (JP)

(21) Appl. No.: 15/255,771

(22) Filed: Sep. 2, 2016

Related U.S. Application Data
(63) Continuation of application No. PCT/JP2015/056075, filed on Mar. 2, 2015.

(30) Foreign Application Priority Data
Mar. 3, 2014 (JP) 2014-040561

(51) Int. Cl. G02B 27/00; G02B 1/10

(52) U.S. Cl. CPC G02B 27/0018; G02B 1/10

(57) ABSTRACT

A method of manufacturing an optical element as defined herein, includes: coating, by an ink jet method, the part of the surface of the optical base member with an ink which contains a light blocking material containing the particles while sequentially shifting, by an interval of T, an area of the surface of the optical base member to be coated with the ink, to form the concave-convex shape of the light blocking layer on the part of the surface of the optical base member.

### CROSS REFERENCE TO RELATED APPLICATION

This is a continuation of International Application No. PCT/JP2015/056075 filed on Mar. 2, 2015, and claims priority from Japanese Patent Application No. 2014-040561 filed on Mar. 3, 2014, the entire disclosures of which are incorporated herein by reference.

### BACKGROUND OF THE INVENTION

1. Field of the Invention

The present invention relates to an electronic apparatus such as a digital camera or a mobile phone, an imaging module that is built into and used in the electronic apparatus, an optical element and a lens unit that are mounted on the imaging module, and a method of manufacturing the optical element.

2. Description of the Related Art

In imaging modules which are built into and used in electronic apparatuses such as digital cameras and mobile phones, unnecessary incident light is eliminated such that flare or ghosts are prevented from occurring. In such a manner, the imaging modules have been improved in terms of image quality of captured images. As a measure of improvement in image quality, for example, there has been proposed a configuration (for example, refer to JP2011-186437A) in which a light blocking layer is directly formed on an optical lens surface used in the imaging module.

In JP2011-186437A, a surface of the light blocking layer provided on the optical lens surface is formed to be uneven. Thereby, incident light onto the light blocking layer surface is prevented from being reflected.

In JP1989-44742A (JP-H01-44742A), although an optical lens for imaging is not described, a transparent molded article having a film, which provides a non-glare property, is described. In the description, the film is configured such that aggregates are uniformly dispersed in the film. By adjusting the distances between aggregates and the average diameter of the aggregates, a favorable non-glare property is obtained.

As a measure of improvement in image quality, for example, JP2013-68688A and JP2013-148844A disclose an imaging apparatus in which a light blocking layer having a diaphragm function is formed on a surface of an infrared cut filter close to an optical lens. The infrared cut filter is provided between an imaging element and the optical lens. According to the imaging apparatus, by preventing obliquely incident light from becoming stray light through the light blocking layer of the surface of the infrared cut filter, it is possible to improve image quality in imaging.

In the description of JP2013-148844A, in order to give a favorable light blocking property to a light blocking layer of an infrared cut filter surface and obtain a low reflectance property, a refractive index or an extinction coefficient of the light blocking layer is defined.

### SUMMARY OF THE INVENTION

In recent imaging modules, there is a demand to satisfy both an increase in diameter of an optical lens for an increase in brightness and reduction in magnification for reduction in size. It can be expected that it will become more and more difficult to cope with this demand in the future. Hence, an angle of incidence of light, which is incident onto a part of the light blocking layer of the optical lens mounted on the imaging module, will further increase in the future. As a result, an effect of reflection of light, which is reflected on the light blocking layer surface, on image quality in imaging will not become negligible.

The film described in JP1989-44742A (JP-H01-44742A) is for better visibility of a display apparatus, and not for light blocking. Further, in JP2011-186437A, there is an object to reduce internal reflection of the light blocking layer, but there is no object to reduce reflection of light which is incident from an air layer side to the light blocking layer. Until now, regarding the light blocking layer provided on the optical lens surface, there is no object to reduce reflection of light on the light blocking layer surface.

Also in a light blocking layer provided on an infrared cut filter, likewise, an angle of incidence of light will further increase in the future. As a result, an effect of reflection of light, which is reflected on the light blocking layer surface, on image quality in imaging will not become negligible. If light is obliquely incident onto the light blocking layer of the infrared cut filter surface, the light is regularly reflected or scattered by the light blocking layer, and returns back in a direction of the incident light. This returning light is highly likely to be reflected on an imaging lens surface and return back to an imaging element, and this is a factor of deterioration in image quality such as ghosting.

JP2013-148844A describes that it is preferable to reduce the reflectance on the light blocking layer of the infrared cut filter surface. However, this reflectance is mainly assumed as reflectance of light which is incident vertically to the imaging element, and there is no consideration of oblique light.

In the description of JP2013-68688A, there is no object to suppress deterioration in image quality caused by such oblique light.

The present invention has been made in consideration of the above-mentioned situation. It is an object of the invention to provide an optical element capable of reducing surface reflection on a light blocking layer so as to avoid ghosting, a lens unit using the optical element, an imaging module using the lens unit, an electronic apparatus using the imaging module, and a method for manufacturing the optical element.

An optical element according to the present invention comprises: an optical base member through which rays pass; and a light blocking layer that is formed on a part of a surface of the optical base member, in which a surface of the light blocking layer has a concave-convex shape in which a plurality of convex portions are two-dimensionally arrayed, and in which assuming that an average height of the plurality of convex portions is H and an average arrangement pitch of the plurality of convex portions is T, H is equal to or greater than 1 μm and equal to or less than 5 μm, and H/T is equal to or greater than 0.1 and equal to or less than 50.

A lens unit according to the present invention comprises one or more optical lenses arranged in an optical axis direction, wherein the optical lens is the optical element.

An imaging module according to the present invention comprises: the lens unit; and an imaging element that captures an image of a subject through the lens unit.

An electronic apparatus according to the present invention is equipped with the imaging module.

In a method of manufacturing the optical element according to the present invention, the light blocking layer is formed on the part of the surface of the optical base member by an ink jet method or a screen printing method using an ink which contains particles of a light blocking material.

According to the present invention, it is possible to provide an optical lens capable of reducing surface reflection on a light blocking layer so as to avoid ghosting, a lens unit using the optical lens, an imaging module using the lens unit, an electronic apparatus using the imaging module, and a method for manufacturing the optical lens.

### BRIEF DESCRIPTION OF THE DRAWINGS

FIG. 1 is a schematic sectional view illustrating an imaging module according to an embodiment of the present invention.

FIG. 2 is a partially enlarged sectional view illustrating a section including an optical axis Ax of an optical lens 15A.

FIG. 3 is an enlarged schematic diagram of a region B of the optical lens 15A shown in FIG. 2.

FIG. 4 is a diagram illustrating relationships between calculated reflectances R1 of simulated light blocking layers and aspect ratios (H/T) of the light blocking layers.

FIG. 5 is a diagram illustrating relationships between calculated reflectances R2 of simulated light blocking layers and aspect ratios (H/T) of the light blocking layers.

FIG. 6 is a diagram illustrating a method of manufacturing the optical lens 15A shown in FIG. 2.

FIG. 7 is a diagram illustrating a method of manufacturing the optical lens 15A shown in FIG. 2.

FIG. 8 is a diagram illustrating a modification example of a method of manufacturing the optical lens 15A shown in FIG. 2.

FIG. 9 is a diagram illustrating a modification example of a method of manufacturing the optical lens 15A shown in FIG. 2.

FIGS. 10A to 10C are diagrams illustrating modification examples of planar shapes of a light blocking layer 16.

FIG. 11 is a diagram illustrating a configuration of a smartphone as an electronic apparatus.

FIG. 12 is a diagram illustrating an internal configuration of the smartphone of FIG. 11.

### EXPLANATION OF REFERENCES

100: imaging module
11: imaging section
110: lens unit
15: optical lens
16: light blocking layer
18: lens base member
18A: lens base member main body
18B: AR coat

### DESCRIPTION OF THE PREFERRED EMBODIMENTS

Hereinafter, embodiments of the present invention will be described with reference to drawings.

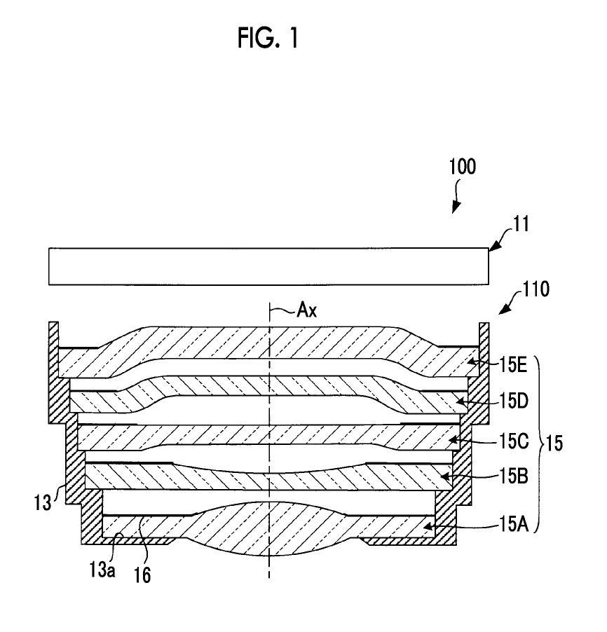

FIG. 1 is a schematic sectional view illustrating an imaging module according to an embodiment of the present invention.

An imaging module 100 has a lens unit 110 and an imaging section 11 that includes an imaging element for capturing an image of a subject through the lens unit 110, and is disposed in a casing of an electronic apparatus such as a smartphone or a digital camera supported by a supporting member such as a substrate which is not shown.

The lens unit 110 has at least one (five in the example of FIG. 1) optical lens 15 which is disposed to overlap in a direction of a lens optical axis Ax inside a lens holder 13. The five optical lenses 15, which are fixed onto the lens holder 13, concentrates light onto the imaging section 11 on the upper side of the drawing from a subject side on the lower side of the drawing, and forms an optical image of a subject on a light receiving surface of the imaging element of the imaging section 11.

FIG. 1 shows examples of five optical lenses 15A, 15B, 15C, 15D, and 15E as the optical lenses 15, but the number of lenses is not limited to this. Further, the optical lenses 15A, 15B, 15C, 15D, and 15E may be configured to be respectively supported by a plurality of lens holders which are individually provided. Furthermore, the lenses may be configured as a zoom lens mechanism, an auto focus mechanism, and an image stabilizer mechanism in which a specific optical lens is supported to be movable in an optical axis direction.

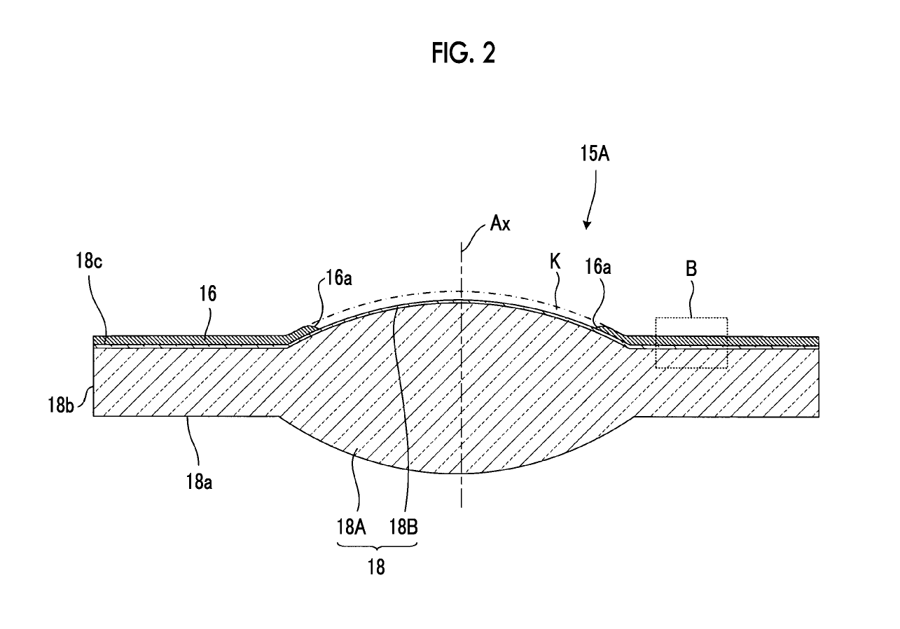

FIG. 2 is a partially enlarged sectional view illustrating a section including an optical axis Ax of an optical lens 15A. The optical lens 15A has a lens base member 18 as an optical base member through which rays are transmitted, and a light blocking layer 16 which is formed on a part of a surface 18c of the lens base member 18.

The lens base member 18 is formed of a lens base member main body 18A and an anti-reflection coat (AR coat) 18B with which light emission side surface of the lens base member main body 18A is covered. The AR coat 18B may be omitted.

As a material of the lens base member main body 18A, a transparent resin material having a high light transmittance, shape stability, and excellent workability is appropriately used. Examples of the materials include cyclic olefin copolymer (COC), cyclo olefin polymer (COP), polycarbonate (PC), and the like.

The light blocking layer 16 is formed on the light emission side surface 18c among surfaces of the lens base member 18. In the light blocking layer 16, an opening K is formed in a region which includes the optical axis Ax of the optical lens 15A as viewed from a subject side, and light, which has been incident into the lens base member 18 from the subject side, is prevented from being incident into the imaging section 11.

The light blocking layer 16 may be formed on a surface 18b, which is supported by the lens holder 13, among the surfaces of the lens base member 18. Further, the light blocking layer 16 may be formed on a part of a light incidence side surface 18a among the surfaces of the lens base member 18.

The light blocking layer 16 may be formed on at least a part of the surfaces 18a and 18c, as shown in FIG. 2.

The light blocking layer 16 can be formed in various methods of printing, coating, stamping, and the like of ink including a material, such as a black pigment or a black dye, with the light blocking property. Among the methods, it is preferable to use an ink jet method or a screen printing method by which it is possible to obtain high dimension accuracy.

As the material with the light blocking property included in the light blocking layer 16, it is possible to use various known black pigments and black dyes. As the black material, it is preferable to use carbon black, titanium black, iron oxide, manganese oxide, and graphite which are capable of achieving a high optical density with a small amount. Further, the black material formed by mixing a red material, a green material, and a blue material may be used.

In recent imaging modules, there is a demand to satisfy both an increase in diameter of an optical lens for an increase in brightness and reduction in magnification for reduction in size. It can be expected that it becomes more and more difficult to cope with this demand in the future. If a focal length decreases in accordance with a decrease in magnification, a viewing angle increases, and thus an angle of incidence of rays, which are incident into the optical lens, increases. Here, the angle of incidence means an angle which is formed between the rays and the optical axis of the optical lens.

If the angle of incidence of rays increases as described above, ghosts increase. Although the light blocking layer 16 using a black ink is employed in order to reduce ghosts, if the reflectance of the light blocking layer 16 increases, ghosts are caused by reflection on the surface of the light blocking layer 16.

Further, if the magnification decreases, it is necessary to rapidly change a path of rays through optical lenses constituting a lens group. Accordingly, more rays, which have been transmitted through the optical lens, tend to propagate toward the sensor side at a large angle to the optical axis. As a result, more rays are incident into the light blocking layer on the lens base member at a large angle. In the light blocking layer such as a black ink, as the angle of incidence of rays increases, the reflectance increases. Hence, ghosts with high intensities occur due to the decrease in magnification.

In view of such a situation, it is necessary to decrease the reflectance of the surface of the light blocking layer 16 with respect to the light (oblique light) incident at a large angle.

The surface of the light blocking layer 16 has a concave-convex shape, thereby achieving characteristics of low reflection with respect to the oblique light due to the concave-convex shape.

FIG. 3 is an enlarged schematic diagram of a region B of the optical lens 15A shown in FIG. 2.

As shown in FIG. 3, the light blocking layer 16 is formed of a planar portion 16A as a portion which has a uniform thickness in a whole area, and convex portions 16B having a plurality of quadrangular pyramid shapes which are two-dimensionally arrayed on the planar portion 16A. The surface of the light blocking layer 16 has a concave-convex shape formed of the plurality of convex portions 16B. The convex portion 16B is not limited to the quadrangular pyramid shape, and may be formed in any shape if the shape is a convex shape such as a conical shape, a triangular pyramid shape, or a prism-like shape.

An average (referred to as an average height H) of heights h of all the convex portions 16B present on the surface of the light blocking layer 16 is equal to or greater than 1 μm and equal to or less than 5 μm. In the example of FIG. 3, the heights of the convex portions 16B are uniform, and thus the height h and the average height H are the same values.

A relationship between the average height H and the average arrangement pitch (indicated by T) of all the convex portions 16B present on the surface of the light blocking layer 16, that is, (H/T) is equal to or greater than 0.1 and equal to or less than 50. It is preferable that (H/T) is greater than 1. In the example of FIG. 3, the convex portions 16B are arrayed in a square lattice shape with a uniform arrangement pitch t. Thus, the arrangement pitch t and the average arrangement pitch T are the same values.

The arrangement pitch t of the convex portions 16B means a maximum value of widths of spaces (concave portions) interposed between every two adjacent convex portions 16B in a direction in which the two convex portions 16B are arranged. The two adjacent convex portions 16B mean that there is no other convex portion 16B between these two convex portions 16B.

The concave-convex shape of the surface of the light blocking layer 16 satisfies the above-mentioned condition, whereby it is possible to avoid ghosting by reducing the reflectance with respect to oblique light.

Among the surfaces of the light blocking layer 16, an inner surface 16a (boundary surface between the surface and the opening K) of the opening K may have a planar shape in which there is no unevenness. The reason for this is that, since the inner surface 16a has a small area, the effect of the reflection of this surface with respect to the oblique light is small. The inner surface 16a is formed in the above-mentioned concave-convex shape, whereby it is possible to further reduce the reflection.

In FIG. 1, a distance from a most-subject-side part of the optical lens 15A, which is closest to a subject among the five optical lenses 15, to a light receiving surface of the imaging element included in the imaging section 11 is TTL, and a composite focal length of the five optical lenses 15 is f. In this case, in the imaging module 100 in which a value obtained by dividing TTL by f is equal to or less than 1.3, the reflection of the surface of the light blocking layer 16 with respect to the oblique light becomes remarkably low by a decrease in magnification. Hence, in the imaging module 100 having a configuration that satisfies the above-mentioned condition, a configuration of the surface of the above-mentioned light blocking layer 16 is particularly effective.

Hereinafter, a result of a study performed on the concave-convex shape of the surface of the light blocking layer 16 will be described.

A study was made on the reflectance of the surface of the light blocking layer 16 having the configuration shown in FIG. 3 when the concave-convex shape of the surface is changed. In this study, a refractive index n and an extinction coefficient k of the light blocking layer 16 with respect to the light of a wavelength of 550 nm were respectively set to n=1.5822 and k=0.22798.

In the configuration shown in FIG. 3, the heights h were respectively set to 0.1 μm, 0.2 μm, 0.3 μm, 0.4 μm, 0.5 μm, 0.6 μm, 1 μm, 2 μm, and 5 μm. At the respective set heights h, the arrangement pitches t were respectively set to 0.1 μm, 0.2 μm, 0.5 μm, 1 μm, 2 μm, 5 μm, 10 μm, 20 μm, and 50 μm. In the configuration of FIG. 3, the height h set herein is the same as the average height H, and the arrangement pitch t set herein is the same as the average arrangement pitch T.

Linearly polarized light with a wavelength of 550 nm was incident onto the surface of the light blocking layer 16, which is set in such a manner, in a direction of an angle (θ1 of FIG. 3) of 60° with respect to the perpendicular line to the planar portion 16A. In this case, simulation is performed on an amount (amount of regularly reflected light) of light, which is reflected in a direction of an angle (θ2 of FIG. 3) of 60° with respect to the perpendicular line to the planar portion 16A, whereby the reflectance R1 is calculated through calculation of (the amount of regularly reflected light/the amount of incident light)×100.

Linearly polarized light with a wavelength of 550 nm was incident onto the surface of the light blocking layer 16, which is set as described above, in a direction of an angle θ1 of 60°. In this case, simulation is performed on a total amount (amount of omnidirectionally reflected light) of light, which is reflected in a direction of an angle of −90° to 90° (the direction of the perpendicular line is set to 0°, the right side of the perpendicular line is set to be positive, and the left side thereof is set to be negative) with respect to the perpendicular line to the planar portion 16A. Thereby, the reflectance R2 is calculated through calculation of (the amount of omnidirectionally reflected light/the amount of incident light)×100.

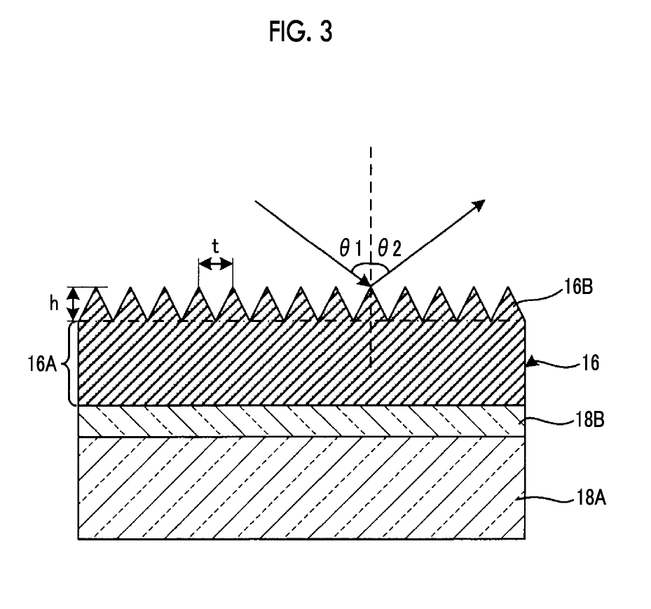

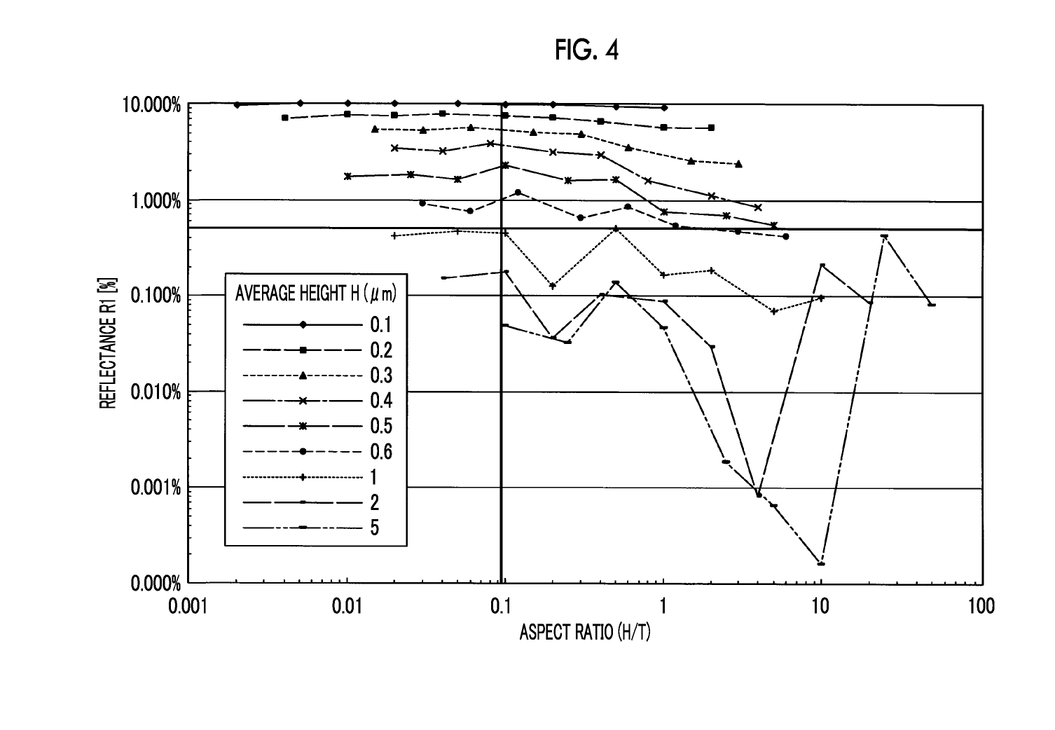

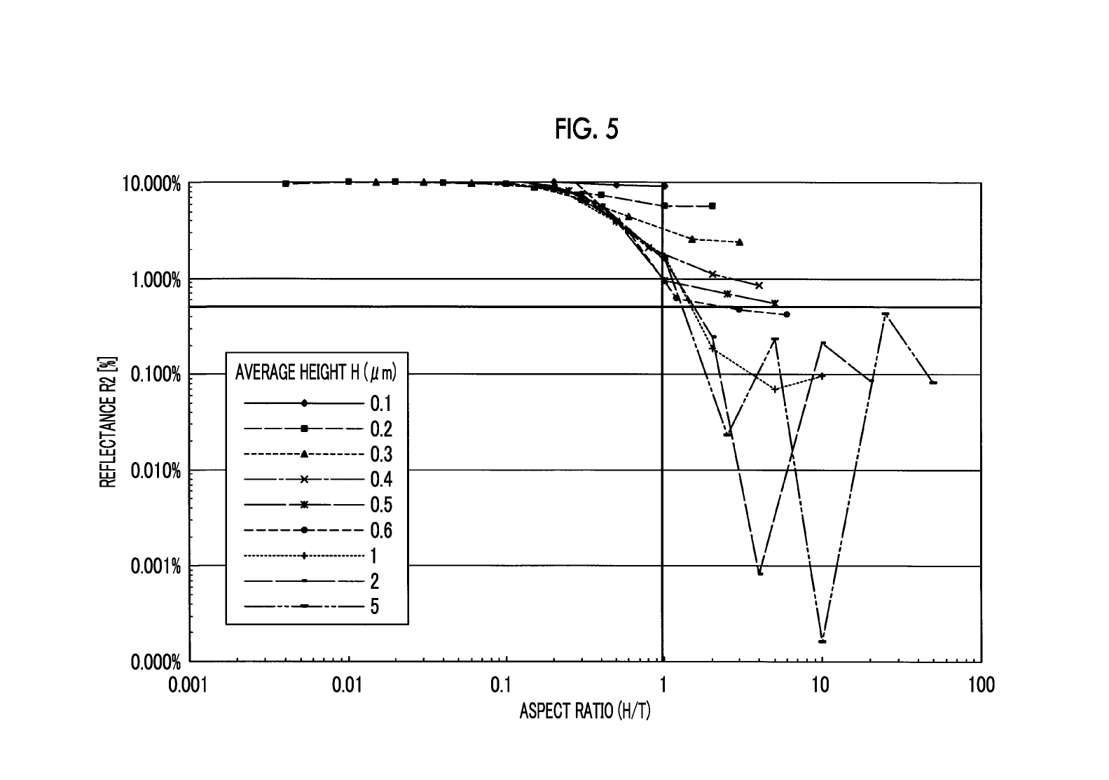

FIG. 4 is a diagram illustrating relationships between the calculated reflectances R1 of the simulated light blocking layers and the aspect ratios (H/T) of the light blocking layers. FIG. 5 is a diagram illustrating relationships between the calculated reflectances R2 of the simulated light blocking layers and the aspect ratios (H/T) of the light blocking layers. FIGS. 4 and 5, both show the vertical axis and the lateral axis in logarithm.

If ghosts are intended to be reduced, it is preferable that the reflectance with respect to light incident at the angle of incidence of 60° is equal to or less than 0.5%. As shown in FIG. 2, the AR coat 18B is generally formed on the lens base member main body 18A, and the reflectance of the AR coat 18B with respect to the light which is incident at the angle of incidence of 60° is generally about 5%.

Accordingly, if the reflectance of the surface of the light blocking layer 16 is 0.5%, the reflectance is sufficiently lower than the reflectance of the AR coat. As a result, even in a case where the oblique light is increased due to a decrease in magnification, it is possible to sufficiently avoid ghosting.

As shown in FIG. 4, the reflectance R1 is equal to or less than 0.5%, when the average height H of the convex portion 16B is equal to or greater than 1 μm and a value of (H/T) is greater than 0.01. If the reflectance R1 is equal to or less than 0.5%, it is possible to sufficiently avoid ghosting. As the result, the value of (H/T) may be equal to or greater than 0.1. The value of (H/T) is more preferably equal to or greater than 0.2, and the value of (H/T) is further preferably equal to or greater than 0.3.

The reflectance R1 is a value relating to light which is obtained from total reflection of the incident light, but a total reflection component thereof has a highest intensity among the components of the reflected light. Hence, if the value of (H/T) can be set to be equal to or greater than 0.1 and the reflectance R1 can be set to be equal to or less than 0.5%, this may be sufficiently effective for avoiding ghosting.

As can be seen from the result of FIG. 4, as the average height H increases, the reflectance R1 tends to decrease. Hence, the average height H may be greater than 5 μm. However, if the average height H is greater than 5 μm, the light blocking layer is unlikely to be formed, or the magnification is inhibited from decreasing due to the increase in thickness of the light blocking layer. Hence, it is preferable that the average height H may be equal to or greater than 1 μm and equal to or less than 5 μm.

The reflectance R2 is a value of a ratio of the amount of omnidirectionally reflected light to the sum of incident light and entire light reflected from the reflective surface. As shown in FIG. 5, the reflectance R2 is equal to or less than 0.5% when the average height H of the convex portions 16B is equal to or greater than 1 μm, and the value of (H/T) is greater than 1 and equal to or less than 10. If the reflectance R2 is equal to or less than 0.5%, it is possible to sufficiently avoid ghosting. Accordingly, as can be seen from the result of FIG. 5, it is preferable that (H/T) is greater than 1 and equal to or less than 10 and the average height H is equal to or greater than 1 μm and equal to or less than 5 μm. The value of (H/T) is more preferably greater than 2 and equal to or less than 9, and the value of (H/T) is further preferably greater than 3 and equal to or less than 8. In a case where the convex portions 16B are formed of silica particles as described later, considering that the particle sizes of the silica particles are as small as about 0.05 μm, the minimum value of the arrangement pitch t is 0.1 μm. Hence, it is preferable that the upper limit of (H/T) is 50 as a value which is calculated from H=5 μm and T=0.1 μm.

Next, an example of the method of manufacturing the optical lens 15A shown in FIG. 2 will be described. Here, a description will be given of an example in which the light blocking layer 16 is formed by the ink jet method or the screen printing method.

As an ink which is discharged from the nozzles of an ink jet apparatus or an ink which passes through a mesh of screen printing, the following is used.

In an ink 60, silica particles 61 are dispersed, and the light blocking layer material is formed. In the ink 60, a photosensitivity monomer, a polymerization initiator, a carbon black, and a solvent (MEK, MIBK, cyclohexane, etc.) are mixed with an appropriate ratio of composition. The silica particles 61 have diameters smaller than diameters of the nozzles of the ink jet apparatus and a diameter of the mesh of the screen printing.

Through the ink jet method or the screen printing method using the light blocking layer material, the lens base member 18 is coated with the light blocking layer material. At this time, an area, in which the convex portions 16B will be formed, is coated with the light blocking layer material so as to include a predetermined number of silica particles.

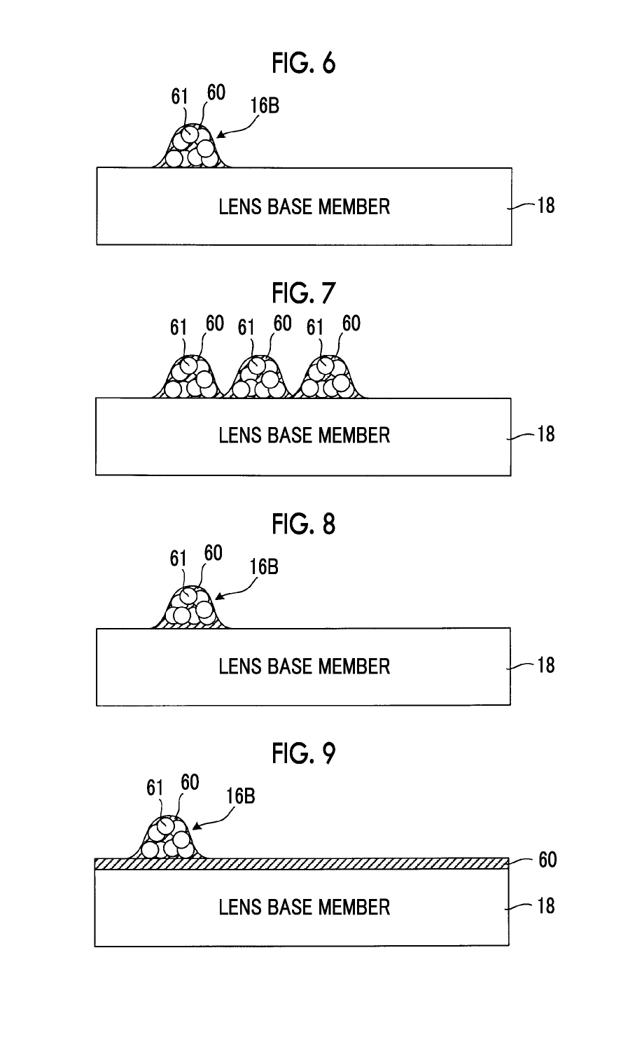

In such a manner, as shown in FIG. 6, in the area, the silica particles 61 aggregate in the ink 60, and the convex portions 16B can be formed of the aggregated silica particles 61 and the ink 60 covering the particles. By sequentially shifting the area to be coated with the light blocking layer material, as shown in FIG. 7, the plurality of convex portions 16B arranged with the predetermined pitch can be formed.

It is preferable that, in consideration of a general nozzle and mesh configuration, the particle sizes of the silica particles are equal to or less than 1 μm. Further, if the particle sizes of the silica particles are extremely small, a huge number of particles is necessary for forming a single convex portion 16B, and it is difficult to control the shape of the convex portion 16B. Accordingly, it is preferable to use the silica particles having the particle sizes of 0.05 μm or more.

The particle sizes of the silica particles, which are included in the light blocking layer 16 of the optical lens manufactured in such a manner, can be measured through image processing from micrographs.

In this method, as shown in FIG. 8, it is preferable that coating of the light blocking layer material is performed such that the silica particles 61 are not in contact with the lens base member 18. If the silica particles 61 are in contact with the lens base member 18, in a case where the silica particles 61 and the lens base member 18 have different refractive indexes, light is likely to be reflected on the interface between the silica particles 61 and the lens base member 18, and this reflected light is likely to deteriorate image quality.

As shown in FIG. 9, the lens base member 18 is coated with the ink 60 which does not include the silica particles 61. Thereafter, the ink 60 is coated with the light blocking layer material in the method described in FIG. 6 such that the convex portions 16B are formed. In this case, it is also possible to achieve a configuration in which the silica particles 61 and the lens base member 18 are not in contact with each other.

The light blocking layer of the optical lens 15A has been hitherto described. However, also in the optical lenses 15B, 15C, 15D, and 15E included in the lens unit 110, the light blocking layer is formed in a way similar to that of the above description. Thereby, it is possible to reliably prevent flare or ghosts from occurring in the entire lens unit 110.

The type of the lens according to the present invention is not limited to concave lenses and convex lenses having the above-mentioned discoidal shapes, and may be a meniscus lens, a cylindrical lens having a cylindrical lens surface, a ball lens, a rod lens, and the like. By providing the above-mentioned light blocking layer in various kinds of lens, it is possible to prevent flare and ghosts from occurring.

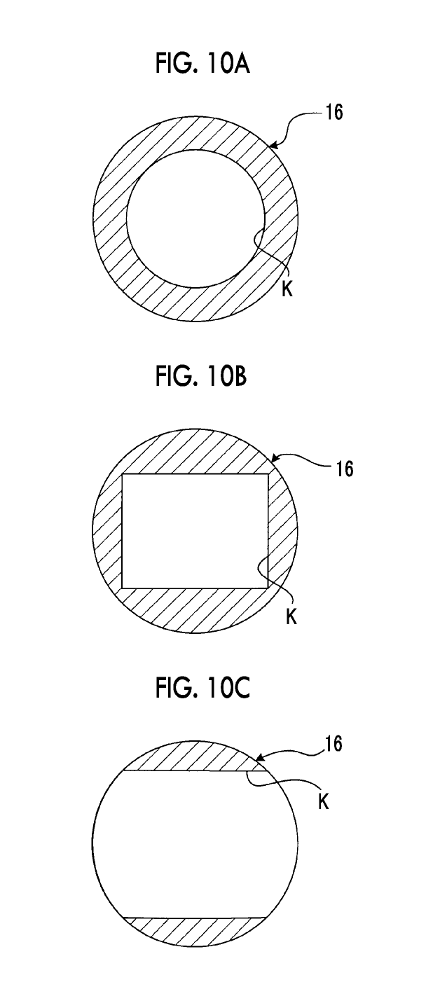

A planar shape of the light blocking layer 16 is annular as shown in FIG. 10A. However, as shown in FIG. 10B, the light blocking layer 16 may be formed to have a rectangular opening K. Further, as shown in FIG. 10C, the light blocking layer 16 may have an opening K having a shape of a circle of which the upper and lower ends are cut off.

In the example hitherto described, as the optical element provided with the light blocking layer, the optical lens is used. However, in a case where the light blocking layer as an infrared cut filter is provided between the imaging element and the optical lens, by applying the present invention, it is possible to prevent ghosts and flare from occurring. In this case, the infrared cut filter serves as an optical base member through which rays (light other than infrared rays) are transmitted.

In the above description, a digital camera is exemplified as a device into which the imaging module 100 is built, but there is no limitation to this. Other examples of the devices, into which the imaging module 100 is built, include electronic apparatuses such as built-in or externally-mounted cameras for a personal computer (PC), camera-equipped interphones, on-board cameras, portable terminal devices having an imaging function, and electronic apparatuses such as an electronic endoscope. Examples of the portable terminal devices include mobile phones, smartphones, personal digital assistants (PDA), portable game machines, and the like.

Hereinafter, an embodiment of a smartphone having a camera section as the imaging apparatus will be described.

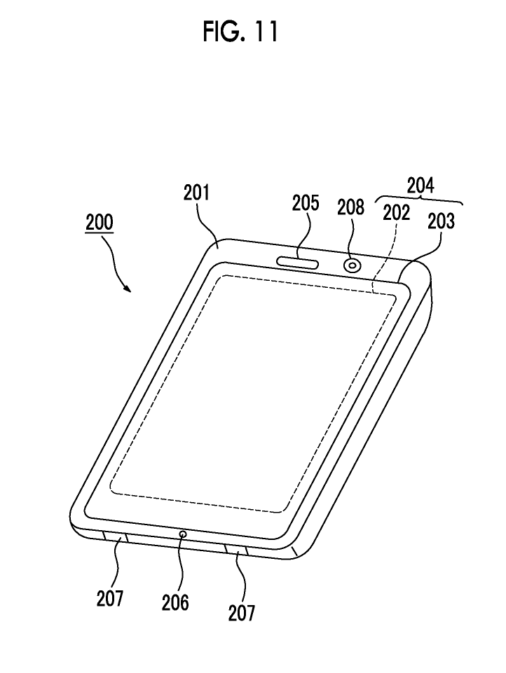

FIG. 11 shows an appearance of a smartphone 200 as a photographing apparatus according to the embodiment of the present invention. The smartphone 200 shown in FIG. 11 comprises: a housing 201 that has a flat plate shape; a display panel 202 as a display section on one side of the housing 201; and a display input section 204 into which an operation panel 203 as an input section is integrated. Further, the housing 201 comprises a speaker 205, a microphone 206, operation sections 207, and a camera section 208. It should be noted that the configuration of the housing 201 is not limited to this. For example, it may be possible to adopt a configuration in which the input section and the display section are independent, or it may be possible to adopt a configuration having a slide mechanism or a folded structure.

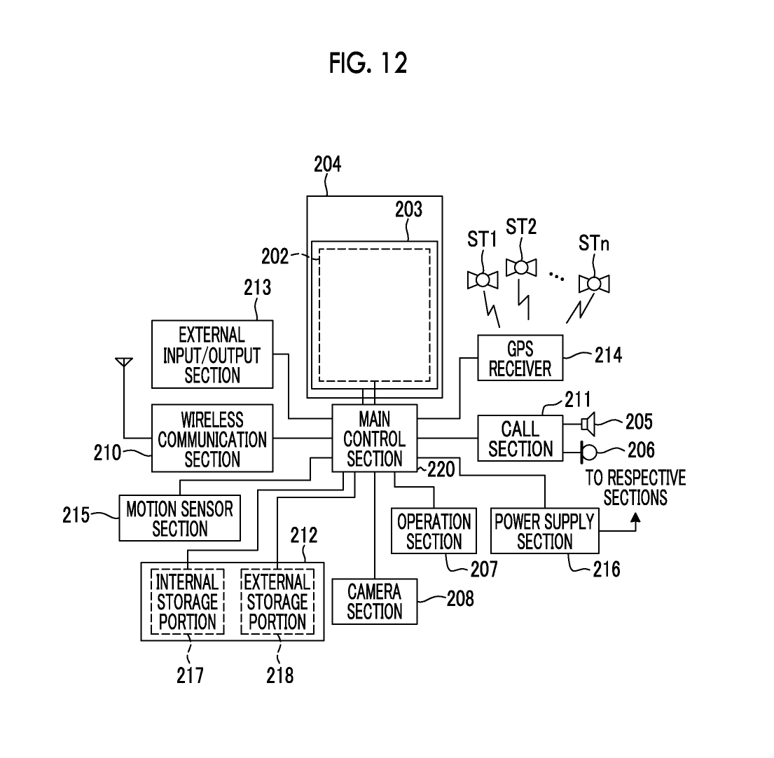

FIG. 12 is a block diagram illustrating a configuration of the smartphone 200 shown in FIG. 11. As shown in FIG. 12, the smartphone comprises, as main components, a wireless communication section 210, a display input section 204, a call section 211, the operation sections 207, the camera section 208, a storage section 212, an external input/output section 213, a global positioning system (GPS) receiver 214, a motion sensor section 215, a power supply section 216, and a main control section 220. As the main function of the smartphone 200, there is provided a wireless communication function for performing mobile wireless communication with a base station device BS, which is not shown, through a mobile communication network NW which is not shown.

The wireless communication section 210 performs wireless communication with the base station device BS, which is included in the mobile communication network NW, in accordance with an instruction of the main control section 220. Using this wireless communication, various kinds of file data such as audio data and image data, e-mail data, and the like are transmitted and received, and web data, streaming data, and the like are received.

The display input section 204 is a so-called touch panel, and includes the display panel 202 and the operation panel 203. The touch panel displays image (still image and moving image) information, text information, or the like so as to visually transfer the information to a user in accordance with control of the main control section 220, and detects a user operation on the displayed information.

The display panel 202 uses a liquid crystal display (LCD), an organic electro-luminescence display (OELD), or the like as a display device.

The operation panel 203 is a device that is provided for viewing an image which is displayed on a display screen of the display panel 202 and that detects a single pair of coordinates or a plurality of pairs of coordinates at which an operation is performed by a user's finger or a stylus. If such a device is operated by a user's finger or a stylus, the device outputs a detection signal, which is generated due to the operation, to the main control section 220. Subsequently, the main control section 220 detects an operation position (coordinates) on the display panel 202, on the basis of the received detection signal.

As shown in FIG. 11, the display panel 202 and the operation panel 203 of the smartphone 200, which is exemplified as the photographing apparatus according to the embodiment of the present invention, are integrated to constitute the display input section 204, and are disposed such that the operation panel 203 completely covers the display panel 202.

In a case where such an arrangement is adopted, the operation panel 203 may have a function of also detecting a user operation in a region other than the display panel 202. In other words, the operation panel 203 may comprise a detection region (hereinafter referred to as a display region) for a part which overlaps with the display panel 202 and a detection region (hereinafter referred to as a non-display region) for the other part at the outer edge which does not overlap with the display panel 202.

It should be noted that a size of the display region and a size of the display panel 202 may completely coincide with each other, but it is not always necessary for both to coincide with each other. Further, the operation panel 203 may include two sensing regions of the outer edge part and the other inside part. Furthermore, a width of the outer edge part is appropriately designed depending on a size of the housing 201 and the like. In addition, examples of the position detection method adopted for the operation panel 203 may include a matrix switch method, a resistance film method, a surface elastic wave method, an infrared method, an electromagnetic induction method, and an electrostatic capacitance method, and the like, and any method may be adopted.

The call section 211 comprises a speaker 205 and a microphone 206. The call section 211 converts a sound of a user, which is input through the microphone 206, into sound data, which can be processed in the main control section 220, and outputs the data to the main control section 220, or decodes sound data, which is received by the wireless communication section 210 or the external input/output section 213, and outputs the data from the speaker 205. Further, as shown in FIG. 11, for example, the speaker 205 can be mounted on the same surface as the surface on which the display input section 204 is provided. In addition, the microphone 206 can be mounted on a side surface of the housing 201.

The operation section 207 is a hardware key using a key switch or the like, and receives an instruction from a user. For example, as shown in FIG. 11, the operation sections 207 are button type switches which are mounted on the side surface of the housing 201 of the smartphone 200. Each switch is turned on if it is pressed by a finger or the like, and is turned off due to restoring force of a spring if the finger is released.

The storage section 212 stores a control program and control data of the main control section 220, application software, address data in which names, phone numbers, and the like of communication partners are associated, received and transmitted e-mail data, web data which is downloaded by web browsing, and downloaded contents data, and temporarily stores streaming data and the like. Further, the storage section 212 is constituted of an internal storage portion 217, which is built into the smartphone, and an external storage portion 218 which has a removable external memory slot. In addition, each of the internal storage portion 217 and the external storage portion 218 constituting the storage section 212 is implemented by using a storage medium such as a flash memory type, a hard disk type, a multimedia card micro type, a card type memory (such as a MicroSD (registered trademark) memory), a random access memory (RAM), or a read only memory (ROM).

The external input/output section 213 has a function of an interface with all external devices connected to the smartphone 200. The external input/output section 213 is for communication with other external devices (such as universal serial bus (USB) or IEEE1394), direct or indirect connection to networks (such as the Internet, wireless LAN, Bluetooth (registered trademark), radio frequency identification (RFID), infrared communication (Infrared Data Association: IrDA) (registered trademark), ultra wideband (UWB) (registered trademark), and ZigBee (registered trademark), or the like).

Examples of the external devices connected to the smartphone 200 include a wired/wireless headset, a wired/wireless external charger, a wired/wireless data port, a memory card which is connected through a card socket, a subscriber identity module (SIM) or user identity module (UIM) card, external audio and video devices which are connected through audio and video input/output (I/O) terminals, external audio and video devices which are connected in a wireless manner, a smartphone which is connected in a wired or wireless manner, a personal computer which is connected in a wired or wireless manner, a PDA which is connected in a wired or wireless manner, an earphone, and the like. The external input/output section 213 is able to transfer the data, which is transmitted from such external devices, to the components within the smartphone 200, and to transmit the data within the smartphone 200 to the external devices.

The GPS receiver 214 receives a plurality of GPS signals, which are transmitted from GPS satellites ST1 to STn, in accordance with instructions of the main control section 220, executes positioning calculation processing based on the received GPS signals, and detects a position formed of a latitude, a longitude, and an altitude of the smartphone 200. The GPS receiver 214 may detect the position by using position information when it is possible to acquire the position information from the wireless communication section 210 or the external input/output section 213 (for example, wireless LAN).

The motion sensor section 215 includes, for example, a triaxial acceleration sensor, and detects physical movement of the smartphone 200, in accordance with an instruction of the main control section 220. By detecting physical movement of the smartphone 200, an acceleration and a direction of the movement of the smartphone 200 are detected. Such a detection result is output to the main control section 220.

The power supply section 216 supplies the respective sections of the smartphone 200 with electric power, which is stored in a battery (not shown), in accordance with an instruction of the main control section 220.

The main control section 220 includes a micro processor, and integrally controls the respective sections of the smartphone 200 by performing an operation on the basis of control data or a control program stored in the storage section 212. Further, the main control section 220 has an application processing function and a mobile communication control function of controlling the respective sections of a communication system in order to perform data communication and sound communication through the wireless communication section 210.

The application processing function is implemented by an operation of the main control section 220 using application software stored in the storage section 212. Examples of the application processing function include: an infrared communication function of performing data communication with other devices by controlling the external input/output section 213; an e-mail function of transmitting and receiving e-mails; a web browsing function of browsing web pages; and the like.

Further, the main control section 220 has an image processing function of displaying a video on the display input section 204 and the like, on the basis of image data (still image and moving image data) such as received data and downloaded streaming data. The image processing function means a function of causing the main control section 220 to decode the image data, apply image processing to the decoding result, and display an image on the display input section 204.

Further, the main control section 220 executes display control for the display panel 202 and operation detection control to detect the user operation through the operation sections 207 and the operation panel 203. Through execution of the display control, the main control section 220 displays an icon for activating application software and a window for displaying a software key such as a scroll bar or creating an e-mail. It should be noted that the scroll bar means a software key for receiving an instruction to move a display portion of an image on a large image which cannot be entirely shown in the display region of the display panel 202.

Further, through execution of the operation detection control, the main control section 220 detects the user operation performed through the operation section 207, receives an operation performed on the icon or a text input performed in an input field of the window through the operation panel 203, or receives a request to scroll a displayed image through the scroll bar.

Furthermore, the main control section 220 has a touch panel control function performed through execution of the operation detection control. The function determines whether the operation position of the operation panel 203 is in the overlapping part (display region) which overlaps with the display panel 202 or the other part (non-display region) at the outer edge which does not overlap with the display panel 202, and controls the display position of the software key or the sensing region of the operation panel 203.

In addition, the main control section 220 may detect a gesture operation performed on the operation panel 203, and may execute a preset function in response to the detected gesture operation. The gesture operation is not a simple touch operation used in the past. The gesture operation means an operation for drawing a locus with a finger or the like, an operation of specifying a plurality of positions at the same time, or an operation of drawing loci from a plurality of positions to at least one position as a combination of the above-mentioned operations.

The camera section 208 includes the imaging module 100 shown in FIG. 1. The captured image data, which is generated by the camera section 208, can be recorded into the storage section 212, or can be output through the input/output section 213 or the wireless communication section 210.

In the smartphone 200 shown in FIG. 11, the camera section 208 is mounted on the same side as the display input section 204. However, the mounting position of the camera section 208 is not limited to this. The camera section 208 may be mounted on the rear side of the display input section 204.

Further, the camera section 208 can be used in various functions of the smartphone 200. For example, an image, which is acquired by the camera section 208, can be displayed on the display panel 202, and an image of the camera section 208 can be used for one of the operation inputs of the operation panel 203. Further, when the GPS receiver 214 detects a position, the GPS receiver 214 may detect the position with reference to an image obtained from the camera section 208. Further, it may be possible to determine a direction of an optical axis of the camera section 208 of the smartphone 200 or determine a current user environment, using the GPS receiver 214 in a combination with the triaxial acceleration sensor or without using the triaxial acceleration sensor, with reference to the image acquired from the camera section 208. Needless to say, the image acquired from the camera section 208 may be used in the application software.

Otherwise, the position information acquired by the GPS receiver 214, the sound information acquired by the microphone 206 (or text information obtained through sound text conversion performed by the main control section or the like), posture information acquired by the motion sensor section 215, and the like may be added to the image data of the still image or the moving image, and the image data may be recorded in the storage section 212, or may be output through the input/output section 213 or the wireless communication section 210.

The present invention is not limited to the embodiments. It is apparent that the configurations of the embodiments may be combined, or may be modified and applied by those skilled in the art on the basis of description of the specification and a known technology. The combinations, modifications, and applications thereof are within the encompassed scope of the present invention.

As described above, the present description discloses the following items.

The disclosed optical element comprises: an optical base member through which rays pass; and a light blocking layer that is formed on a part of a surface of the optical base member. A surface of the light blocking layer has a concave-convex shape in which a plurality of convex portions are two-dimensionally arrayed. Assuming that an average height of the plurality of convex portions is H and an average arrangement pitch of the plurality of convex portions is T. H is equal to or greater than 1 μm and equal to or less than 5 μm. H/T is equal to or greater than 0.1 and equal to or less than 50.

In the disclosed optical element, H/T is greater than 1.

In the disclosed optical element, the convex portions are formed by aggregating particles, and an average particle sizes of the particles are equal to or greater than 0.05 μm and equal to or less than 1 μm.

In the disclosed optical element, the optical base member is not in contact with the particles of the light blocking layer.

In the disclosed optical element, the light blocking layer has a structure in which a first layer and a second layer are laminated. The first layer does not include the particles which are formed on the optical base member. The second layer includes the particles which are formed on the first layer.

In the disclosed optical element, in the light blocking layer, an opening is formed in a region which includes an optical axis of the optical base member as viewed from a subject side, and the surface of the light blocking layer includes an inner surface of the opening.

In the disclosed lens unit, the optical element is an optical lens, and the optical lens is one or more lenses which are arranged in an optical axis direction.

The disclosed imaging module comprises: the lens unit; and an imaging element that captures an image of a subject through the lens unit.

In the disclosed imaging module, assuming that a distance from a part of the one or more optical lenses closest to the subject side to the imaging element is TTL and a composite focal length of the one or more optical lenses is f, TTL/f≦1.3.

The disclosed electronic apparatus is equipped with the imaging module.

In the disclosed method of manufacturing the optical element, the light blocking layer is formed on the part of the surface of the optical base member by an ink jet method or a screen printing method using an ink which contains particles of a light blocking material.

### INDUSTRIAL APPLICABILITY

The present invention is highly convenient and effective to be applied to particularly portable electronic apparatuses such as digital cameras and mobile phones.

The present invention has been hitherto described with reference to the specific embodiments. However, the present invention is not limited to the embodiments, and may be modified into various forms without departing from the technical scope of the present invention.

The present application is based on Japanese Patent Application (JP2014-040561A) filed on Mar. 3, 2014, the content of which is incorporated herein by reference.

What is claimed is:

1. A method of manufacturing an optical element,
wherein the optical element comprises an optical base member through which rays pass; and a light blocking layer that is formed on a part of a surface of the optical base member, in which a surface of the light blocking layer has a concave-convex shape in which a plurality of convex portions, which are made by aggregate of particles, are two-dimensionally arrayed, and assuming that an average height of the plurality of convex portions is H and an average arrangement pitch of the plurality of convex portions is T, H is equal to or greater than 1 μm and equal to or less than 5 μm, and H/T is equal to or greater than 0.1 and equal to or less than 50; and
wherein the method comprises: coating, by an ink jet method, the part of the surface of the optical base member with an ink which comprises a light blocking material comprising the particles while sequentially shifting, by an interval of T, an area of the surface of the optical base member to be coated with the ink, to form the concave-convex shape of the light blocking layer on the part of the surface of the optical base member.
